(19) United States
(12) Patent Application Publication
(10) Pub. No.: US 2008/0115703 A1
(43) Pub. Date: May 22, 2008

(54) Security Case, Security System, And Security Complex

(76) Inventor: Peter Villiger, Beinwil (CH)

Correspondence Address: MCCARTER & ENGLISH LLP;CITYPLACE I, 185 ASYLUM STREET, HARTFORD, CT, 06103, US

(21) Appl. No.: 11/663,109

(22) PCT Filed: Aug. 24, 2005
(86) PCT No.: PCT/EP05/54156

§ 371 Date: Sep. 11, 2007

(30) Foreign Application Priority Data
Sep. 17, 2004 (CH) 01532/04

(51) Int. Cl. E05G 1/14; E05G 1/00; E05G 1/08

(52) U.S. Cl. 109/25; 109/45; 109/46

(57) ABSTRACT

There is provided a security case with a strongbox area for receiving valuables. The case includes a protection system for protecting the valuables located in the strongbox area. The protection system also includes at least two protection modules, which are situated in the strongbox area and implemented for the purpose of automatically neutralizing the valuables from two sides in case of emergency. An access opening with a sliding plate is provided, which is situated in the area of a case wall and which is movable by a translational movement between its cover position and its release position.

### CROSS REFERENCE TO RELATED APPLICATIONS

This application is the U.S. National Phase of International Application No. PCT/EP2005/054156, filed Aug. 24, 2005, which claims priority to Swiss Application No. CH 01532/04, filed Sep. 17, 2004, the contents of which are expressly incorporated by reference in their entirety as part of the present disclosure.

### BACKGROUND

1. Field of the Invention

The present invention relates to a security case having a strongbox area for receiving valuables, a protection system for protecting the valuables located in the strongbox area, an access opening, and a cover, which may be moved from a cover position, in which the access opening is covered, into a release position, in which the access opening is exposed. The present invention also relates to a security system, and a security complex having a security case and an external container.

2. Description of the Related Art

Security cases of the type cited are used for transporting objects in need of protection, such as valuables like coins and banknotes, securities, other valuable objects such as precious metals and precious stones, documents to be kept secret, or possibly also toxic materials, rare materials, or material to be shielded in another way, such as radioactive material.

The security cases include a strongbox area, a protection system, an access opening, to open the security case and make the security case accessible, and a cover.

The protection system is used for the purpose of protecting the owner or possessor of the valuables from a misuse of the valuables, if they are lost in the event of a theft. This is performed by automatically devaluing the valuables in such a case.

The cover is movable back and forth between a closed position and a release position. During transport of the valuables, the cover assumes its closed position and closes the access opening. If valuables are to be introduced into the strongbox area or removed therefrom, the cover is brought into its release position, in which the access opening is open.

Security systems of the type cited, comprise one or more security cases and at least one storage station. The storage station has storage points for one or more security cases. Empty security cases, but also security cases containing valuables, may be received in each storage point, for example, during a transport interruption. The security systems may be housed in a vehicle, for example.

In a simple embodiment, security complexes of the type cited comprise at least one security case and at least one external container, in particular a strongbox. The security case is typically mobile and the external container may be mobile or stationary. Measures may be provided in the security complexes to ensure secure transfer of the valuables from the security case to the external container. A security complex may be housed in a vehicle, for example.

Expanded security complexes comprise a security case, storage stations, and external containers.

### SUMMARY

It is the object of the present invention,
to provide a security case of the type cited at the beginning, which ensures high security and is simple to handle,
to suggest a polyvalent security system of the type cited at the beginning, and
to specify a security complex of the type cited at the beginning, which allows simple and secure transfer of the values from the security case into the external container.

This object is achieved by a security case including a strongbox area for receiving valuables, a protection system for protecting the valuables located in the strongbox area, an access opening, to be able to open the security case and make the strongbox area accessible, a cover, which may be moved from a cover position, in which the access opening is covered, into a release position, in which the access opening is exposed, and a recessed grip located in the area of a second case wall, to make the security case portable. The access opening is located on a first case wall of the security case, and the cover is a sliding plate situated in the area of a cited case wall, which is guided on the security case in such a way that it is movable by a translational movement between its cover position and its release position. The protection system includes at least two protection modules which are situated in the strongbox area and implemented for the purpose of automatically neutralizing the valuables from two sides in case of emergency. A security system includes the security case and a storage station having storage points for at least one security case.

A security complex includes the security case and an external container. The security case includes connection means, which are implemented in such a way that the security case, having the sliding plate in the closed position, is connectable to the external in such a way that the sliding plate may be moved from its closed position into its release position after being situated on the external container. The external container has a closable security opening to be opened, and the security case is connectable to the external container in such a way that the sliding plate adjoins the security opening of the external container in its closed position, and releases a falling path from the strongbox area of the security case into the external container for the valuables in its release position.

Preferred refinements of the security case, the security complex, and the security system are defined by the particular dependent claims.

In the novel security case, the entry and/or the access opening is located on a first, preferably planar or possibly curved case wall. It is especially advantageous, particularly if the security case is used in a security system according to the present invention, if the access opening is situated in the lower, essentially planar case wall, i.e., in the floor of the security case.

The cover, using which the access opening is closable, essentially comprises a sliding plate, which is also planar or possibly curved in accordance with the area of the case wall which contains the access opening. The sliding plate is guided on the cited case wall of the security case and may be moved back and forth manually, possibly using aids, essentially along the face of the cited case wall between its closed position and its release position. If the case wall and the sliding plate are planar or only singly curved, this movement is translational.

The protection system comprises at least two protection modules, which are situated diagonally or opposite one another in the strongbox area. These protection modules are used for the purpose of neutralizing (devaluing), i.e., damaging or destroying, the valuables located therein, in case of emergency, i.e., if the security case is wrongfully handled or actuated.

The valuables are preferably packed in security pouches and these pouches are then laid in the strongbox area of the security case. These security pouches have an ignition fuse, which is connected to a circuit of the security case. In case of emergency, the security pouches are melted by the ignition fuse before the two protection modules neutralize the valuables using ink or similar material.

A handle or a recessed grip is situated in the area of a second case wall, at which the security case may be carried manually, possibly with the aid of an auxiliary device. The recessed grip may be implemented in such a way that it has a light barrier or a mechanical interrupter. As soon as the currency carrier or another authorized individual lets go of the security case, the neutralization procedure is triggered. This procedure may be implemented in multiple stages and is externally settable (by a Pocket PC or a computer) in a preferred embodiment.

A part of the protection system is housed inside the security case itself in the area of a case wall, preferably in the area of the second case wall. This is preferably an electrical/electronic circuit. This circuit is a part of the protection system. It is an advantage of the present invention that this part of the protection system is located in a protected area of the security case and therefore, in contrast to conventional achievements of the object, may not be externally accessed or influenced. In addition, it is seen as an advantage of the present invention that this part of the protection system is in a part of the case which is not moved during opening and closing of the security case. Therefore, a reliable and secure connection between the part of the protection system and the protection modules may be ensured, which is difficult in conventional cases.

As already noted, the security system according to the present invention comprises one or more security cases of the type described above and one or more storage stations. Each storage station has one or more storage points for one security case each, and it is preferably capable of restoring the security case located and/or docked therein, i.e., checking its security modules and possibly refilling them, and also checking the state of its energy accumulators and recharging them if needed.

The security complex according to the present invention comprises at least one security case and at least one external container, typically in the form of a strongbox. The security case compatible with the external container has novel connection means, which are used for the purpose of temporarily connecting it to the external container. The external container has a closable or closed security opening for this purpose. The security case is connected to the external container in such a way that the sliding plate located in the closed position covers the area of the security opening. The sliding plate may be shifted into its release position after the connection/locking of the security case to the external container. A path results between the strongbox area of the security case and the interior of the external container. In order to convey valuables easily and without further manual measures from the strongbox area into the external container, it is advantageous if the configuration is such that this path drops diagonally or vertically starting from the strongbox area. In order to convey valuables easily and without further measures from the external container into the strongbox area, it is advantageous if the configuration is such that this path drops diagonally or vertically starting from the external container.

In an especially advantageous embodiment, the access opening is located in the lower case wall, i.e., in the floor, or in a side wall of the security case. To deliver valuables to a compatible external container, the case may simply be placed on this external container, so that when the sliding plate of the security case and the security opening of the external container are opened, the valuables may fall out of the strongbox area into the external container. To accept valuables from an external container, the same security case may be reversed and situated below the external container, so that when the sliding plate of the security case and the security opening of the external container are opened, the valuables fall out of the external container into the strongbox area.

The same effect of gravity conveyance of the valuables may also be achieved using a configuration in which the access opening and the sliding plate of the security case are situated in the lowermost area of a diagonal lateral wall of the security case, and/or in a configuration in which the security opening does not lie in a horizontal plane. It is recognizable to those skilled in the art without further measures that greatly varying configurations are possible in this regard. It is only essential that the path of the valuables originates from the lowermost area of the strongbox area and/or the external container and leads downward.

### BRIEF DESCRIPTION OF THE DRAWINGS

Further features and characteristics of the present invention are explained in greater detail in the following on the basis of exemplary embodiments and with reference to the drawing.

FIG. 1 shows the present invention in overview, in a schematic illustration;

FIG. 2A shows a security case according to the present invention in a diagram;

FIG. 2B shows the security case illustrated in FIG. 2A, having partially removed walls, in the same illustration as FIG. 2A;

FIG. 2C shows a detail of the security case illustrated in FIG. 2A, the sliding plate being partially opened;

FIG. 3 shows a storage station;

FIG. 4A shows a security complex;

FIG. 4B shows a detail of a further security complex;

FIG. 4C shows a detail of a further security complex;

FIG. 5 shows a further security complex in various positions of the locking mechanism.

### DETAILED DESCRIPTION

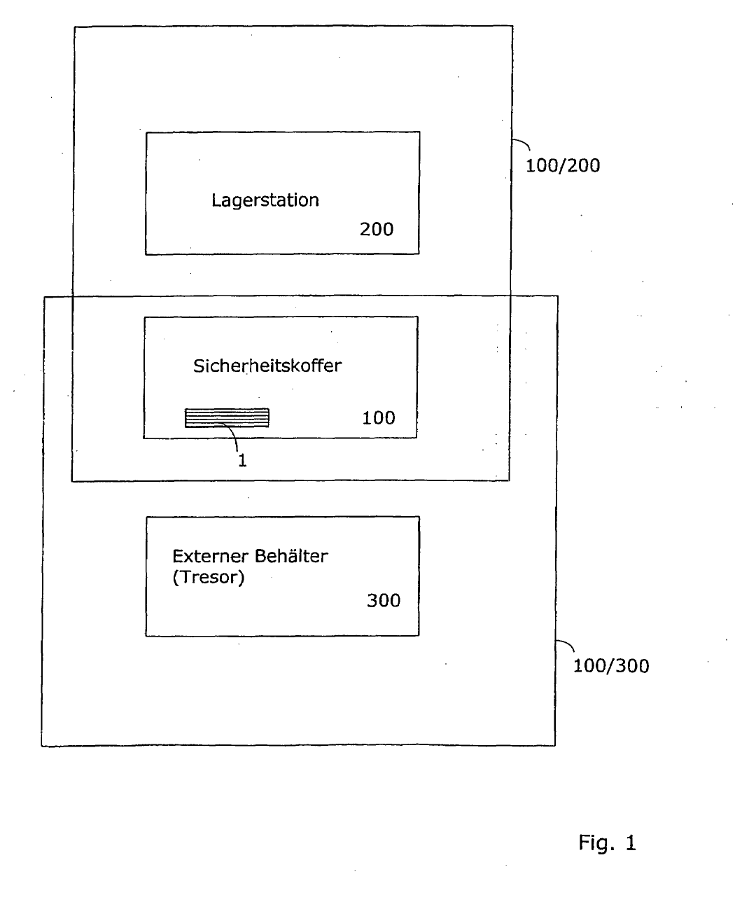

FIG. 1 shows a schematic overview of the present invention. A security case 100, which is used for receiving valuables 1, particularly during transport, forms the core of the present invention. A storage station 200, in which the security case 100 may be received before and after transports and during transport interruptions, forms a security system 100/200 together with the security case 100. The security case 100 may also be restored in the storage station 200. An external container 300, generally a strongbox, to which the security case 100 may be temporarily connected, forms a novel security complex 100/300 together with the security case 100. The security case 100 forms an expanded security complex 100/200/300 together with the storage station 200 and the external container 300.

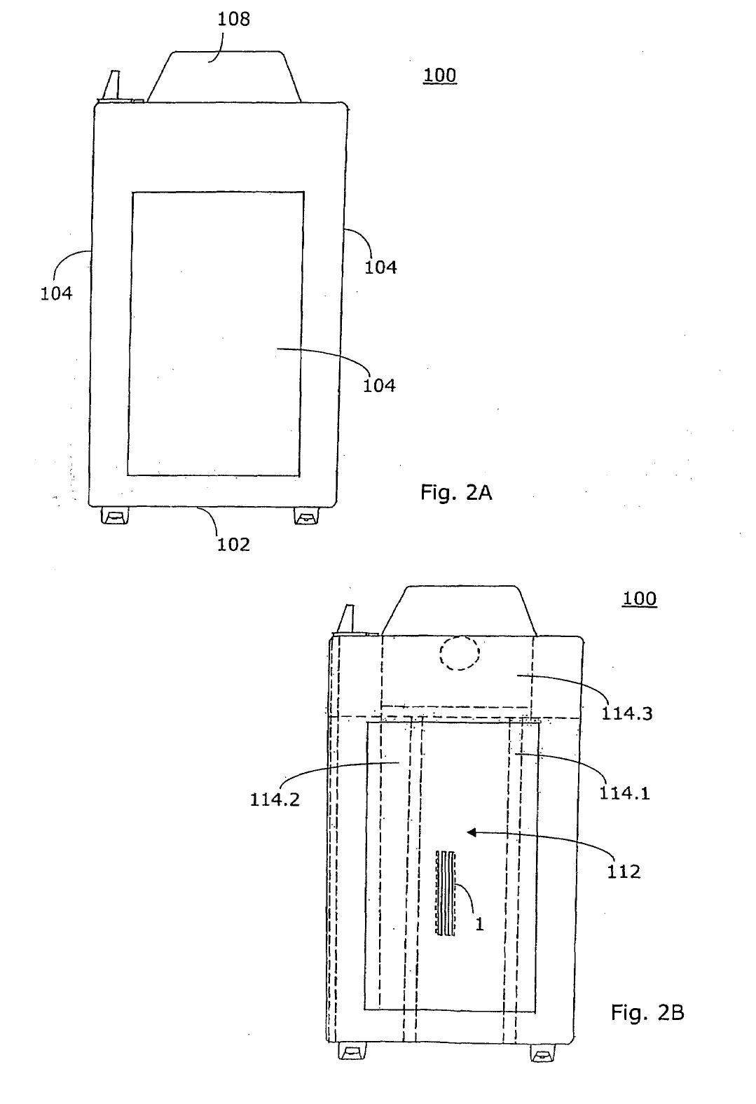

An exemplary embodiment of the security case 100 is illustrated in greater detail in FIGS. 2A and 2B. The security case 100 is essentially cubic and has a lower case wall 102 as a floor, as well as four lateral case walls 104 and an upper case wall 106 as the upper delimitation.

One of the six case walls of the security case 100, in the present case the top case wall 106, has a recessed grip 108 and/or a corresponding handle or a docking system, which is used for the purpose of transporting the security case 100, generally without further aids and manually. Measures may also be taken to manually lift and displace the security case 100 with the aid of an additional device, or to transport the security case 100 in an automated conveyor facility. The recessed grip 108 or another area of the security case 100 may be implemented in such a way that the security case 100 triggers the neutralization via a light barrier or a cable in the event it is snatched or put down. In combination with the recessed grip 108 or another way, an interface 110 may also be provided, whose purpose is explained below. A strongbox area 112 is located in the interior of the security case 100, which is provided for receiving the valuables 1.

A protection system 114 is used for protecting the valuables 1 located in the strongbox area 112. The protection system 114 comprises at least two protection modules 114.1, 114.2, which are situated in the strongbox area 112 and/or adjoining the space intended for receiving the valuables 1, and a circuit 114.3. The protection modules 114.1, 114.2 are situated diametrically opposite one another in the exemplary embodiment shown, but they may also be situated diagonally. The protection system 114 is used for the purpose of protecting the valuables 1 located in the strongbox area 112 in case of emergency, i.e., for example, if the security case 100 is handled or actuated by an individual unauthorized for this purpose, or above a specific temperature. This protection comprises preventing misuse of the valuables 1 by neutralizing (devaluing) them in a suitable way. This neutralization may be performed, for example, in such a way that the valuables 1 may maintain or reacquire their value for the authorized owner or possessor.

The security case 100 is preferably designed in such a way that the ignition fuse of a security pouch (safe bag) may be connected to the circuit 114.3.

The valuables 1 are located in the security pouch. In case of emergency, the security pouch is melted by the ignition fuse before the protection modules 114.1, 114.2 are triggered to perform the neutralization, as described.

The protection modules 114.1, 114.2 of the protection system 114 are modules having free-flowing materials in the present exemplary embodiment, which may discharge powdered, pasty, or liquid materials, in particular inks, preferably under pressure from two sides onto the valuables 1, through which the latter are devalued.

The protection system 114 advantageously has a circuit 114.3 connected to the protection modules 114.1, 114.2, by which the protection modules 114.1, 114.2 are triggered as soon as the security case 100 is handled in an unauthorized way.

The protection system 114 may be implemented in such a way that it is possible to access the strongbox area 112 with or without actuation of an additional auxiliary element such as a (contactless) key.

The security case 100 has an access and/or entry opening 116 in the area of a case wall 104, by which the strongbox area 112 may be made accessible. The access opening 116 is provided with a cover 118. The cover is formed here by a sliding plate, also identified by 118, which is essentially planar. The sliding plate 118 may be moved back and forth, guided on the security case 100 by guide elements (e.g., by lateral grooves), in the face of the case wall 104 between a closed position and a release position. If the sliding plate 118 assumes its closed position, the access opening 116 is closed. If the sliding plate 118 assumes its release position, the access opening 116 is released and valuables 1 may traverse the access opening 116. The sliding plate 118 is preferably attached to an area of the security case 100 in such a way that it remains at least loosely connected to the security case 100 even in its release position.

The sliding plate 118 may be protected electrically and/or mechanically against manipulations. In particular, encryption means may be provided which only allow sliding of the sliding plate 118 into its release position when specific security conditions have been fulfilled in the surroundings.

A thermoplastic material, preferably a kydex® material has been shown to be a suitable material for the security case 100 or parts thereof. However, greatly varying other materials are also suitable for producing the security case 100.

The security case 100 preferably has a surface protection. For this purpose, the security case 100 may be provided with a protective film, a net, or a fabric to provide a protection against breaking open, cutting through, or drilling through. Such a surface protection may also be provided analogously on the strongbox 300.

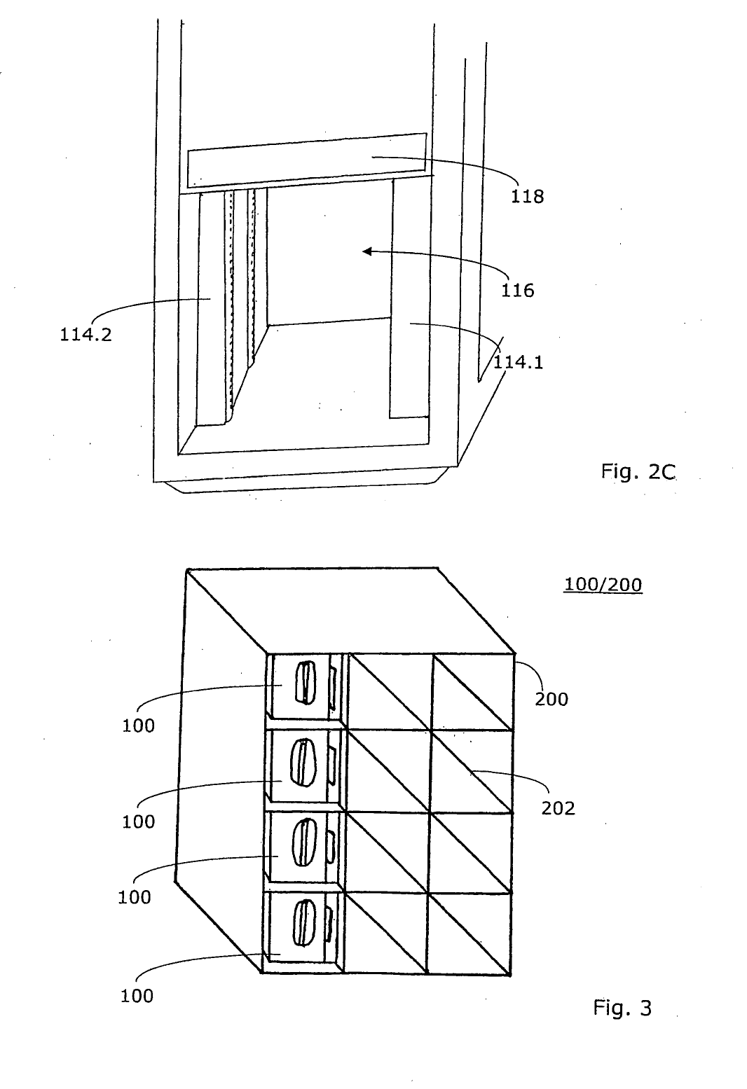

The security case 100 and/or multiple security cases form, as already noted, the security system 100/200 together with the storage station 200. The storage station 200 has storage points 202 for one or more security cases 100 as shown in FIG. 3. The storage station 200 is housed either in a building or in a transport unit, in particular in a vehicle. The security system 100/200, i.e., the storage station 200 having a specific number of security cases 100, may be transported as a whole.

The security system 100/200 may be used in a suitable embodiment as a variable size strongbox, the security cases 100 situated in the storage station 200 forming partial strongboxes. The storage station 200 is used not only for simply receiving the security case 100, preferably, means are also provided which prevent unauthorized removal of the security case 100 from its storage point 202 or at least indicate it by a signal. For this purpose, the security cases may be mechanically and/or electrically secured.

The storage station 200 is implemented in such a way that it has at least one storage point 202, in which the security case 100 may not only be stored but rather may be docked in a certain sense, in such a way that a connection with corresponding elements of the storage station 200 is produced via the interface of the security case 100 cited above, via which, for example, protection modules 114.1, 114.2 may be refilled and an energy accumulator may be recharged, the storage station being used as a type of adapter. The protection modules 114.1, 114.2 are preferably filled by hand. The cited interface is solely used in this case for charging a circuit 114.3, which is a component of the protection system 114.

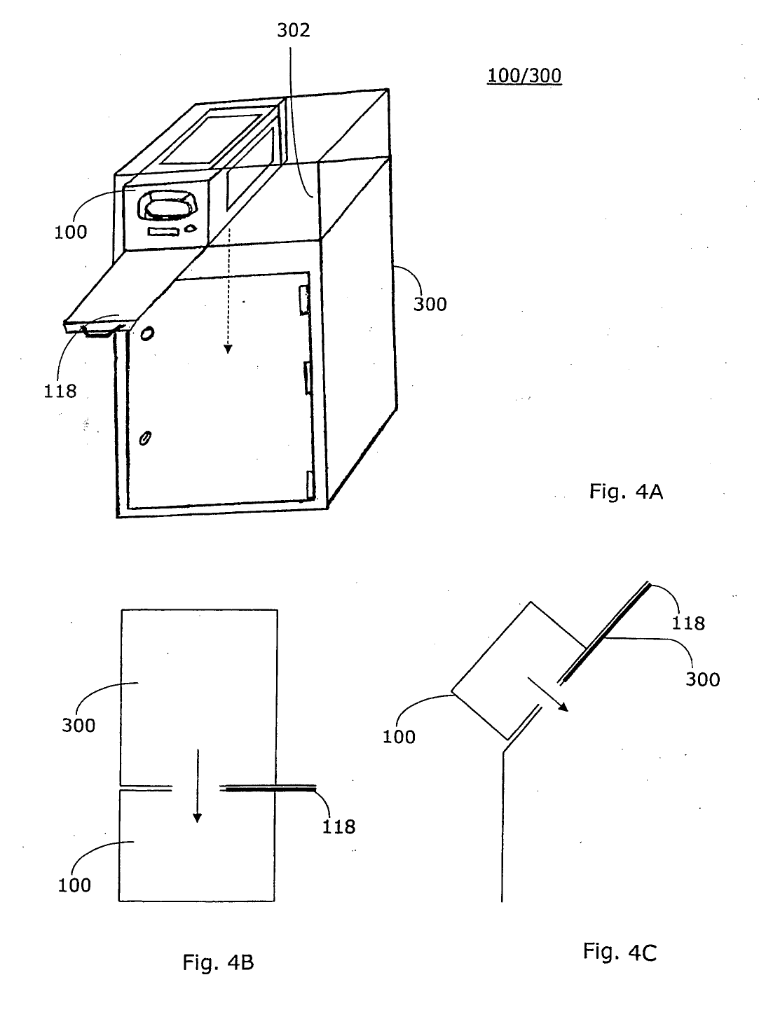

The protection complex 100/300 comprises, as illustrated in FIG. 4A, the security case 100 and an external container 300 (strongbox). The external container 300 has an external wall 302 having a security opening, which is not shown in FIG. 4A. The external surface 302 is implemented in such a way that, at least in the relevant area, it is essentially complementary to the case wall which contains the access opening 116 and the sliding plate 118, in the present case as complementary to the case wall 102.

To move valuables 1 from the security case 100 into the external case 300, as shown in FIG. 4, the security case 100 having the case wall 102, which has the sliding plate 118 or is formed by the sliding plate 118, is laid on the external container 300 and/or placed on the container 300 in the exemplary embodiment described. Mechanical stops may be provided on the security case 100 and/or on the container 300, which ensure the correct positioning of the security case 100. At the correct positioning of the security case 100 on the container 300, the access opening 116 of the security case 100 comes to rest essentially aligned with the security opening of the container 300, the strongbox area 112 of the security case 100 electrically/electronically communicating with the container 300. The communication is performed via a plug connection or wirelessly.

It would also be possible to implement the security case 100 and the container 300 in regard to their external shapes in such a way that in any case only precise positioning of the security case 100 in the required position on the container 300 is possible. This embodiment is especially preferred.

While the security case 100 is placed on the container 300, the sliding plate 118 is still in its closed position. The sliding plate 118 is then put into its release position, so that the access opening 116 and thus also the strongbox area 112 are open, as indicated in FIG. 4A. The security opening of the container 300 is preferably mechanically opened by the sliding of the sliding plate 118, an electronic release previously occurring.

After the access opening 116 and the security opening are opened, the strongbox area 112 communicates with the interior of the container 300, i.e., a path is formed along which the valuables 1 may arrive in the container 300 from the security case 100, as indicated in FIG. 4A on the basis of a dashed arrow. In the present exemplary embodiment, this path leads vertically downward starting from the security case 100, so that the valuables move under the effect of gravity.

Such a gravity conveyance is also possible in configurations in which this path does not lead vertically downward, but rather diagonally. Furthermore, it is possible to situate the security case and the container in such a way that a path for the valuables which drops slightly or not at all is formed, as indicated in FIG. 4C. In this case, additional measures must be taken to convey the valuables from the security case 100 into the container 300, for example, by shaking and/or rotating the security complex 100/300 or by generating a pressure gradient between the security case 100 and the container 300. The sliding plate 118 is shown in the open state in FIG. 4C.

An embodiment is shown in FIG. 4B, in which the security case 100 is seated below the container 300 and the container 300 may be unloaded by the effect of gravity. The sliding plate 118 is shown in the open state in FIG. 4B.

If the security case 100 or its strongbox area 112 has multiple compartments, for example, for different coins, a container 300, whose interior is also divided into compartments, is advantageously used. The security case 100 is then positioned on the container 300 in such a way that when the sliding plate 118 is opened, separated paths for the individual types of coins arise, so that the corresponding compartments of the security case 100 on one side and the container 300 on the other side communicate.

In an analogous way, which is therefore not described further, the valuables 1 may also be conveyed from the container 300 into the security case 100. For this purpose, if the security case 100 illustrated in FIGS. 2A through 2C is used, the container 300 must have a bottom security opening. The security case 100 is then placed under the container 300 having case wall 102 and/or sliding plate 118 on top, where it is held by support elements and then opened. This principle is shown in FIG. 4C.

Alternatively, a security case 100 may be used which has a further access opening on its upper case wall, which requires lateral positioning of the recessed grip, however.

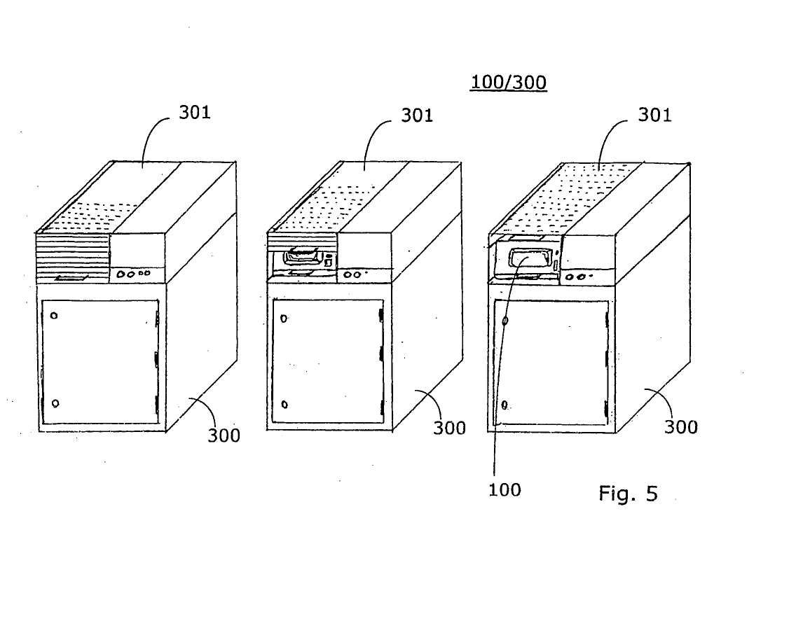

A further protection complex 100/300 is shown in FIG. 5, which comprises a security case 100 and an external container 300 (strongbox). A state is shown in the right figure shortly after the security case 100 has been placed on the strongbox. By manually or automatically closing a lock, which is implemented in the present example as a roller shutter 301, the security case may be connected to the strongbox 300. According to this embodiment, the sliding plate 118 may be opened and the security case 100 may be connected to the interior of the strongbox 300 only after the closing.

The security case 100 is preferably designed in such a way that it has an interface to allow a release of the security case 100 using a Pocket PC or computer. For this purpose, the Pocket PC or computer is equipped with special software which allows the release after input of a suitable security identifier (PIN).

In another preferred embodiment, the security case 100 has an interface to read an RFID chip or barcode, in order to only then allow a release of the security case 100. Such an RFID chip or barcode may be situated at the target location (such as a bank). The security case 100 is then only released after recognition of the RFID chip or the barcode.

Preferably, a sidewalk time window may be predefined for the circuit of the security case, the automatic neutralization being initiated after the sidewalk time window has been exceeded. The circuit of the security case is preferably designed in such a way that an LED begins to blink in case of emergency after a bouncing time. A prealarm then occurs, for example, acoustically, followed by a main alarm. The neutralization is first performed after this alarm phase. The sequence is preferably externally programmable (using a Pocket PC or computer).

Smoke is preferably discharged by the security modules in the security case upon the neutralization. This has a signal effect and thus prevents a perpetrator from carrying along the security case.

The container 300 may also be equipped with security modules to perform a neutralization.

It is an essential advantage of the combination of a security case 100 with a container 300 that no external access to the valuables is possible during the drop case transfers.

1. A security case comprising:
a strongbox area for receiving valuables,
a protection system for protecting the valuables located in the strongbox area,
an access opening, to be able to open the security case and make the strongbox area accessible,
a cover, which may be moved from a cover position, in which the access opening is covered, into a release position, in which the access opening is exposed, and
a recessed grip located in the area of a second case wall, to make the security case portable,
wherein the access opening is located on a first case wall of the security case, the cover is a sliding plate situated in the area of a cited case wall, which is guided on the security case in such a way that it is movable by a translational movement between its cover position and its release position, and the protection system includes at least two protection modules, which are situated in the strongbox area and implemented for the purpose of automatically neutralizing the valuables from two sides in case of emergency.

2. The security case according to claim 1, wherein the sliding plate is electrically and/or mechanically protected against manipulations.

3. The security case according to claim 1, wherein the sliding plate is provided with closure means, in order to release the sliding plate only when specific security conditions have been fulfilled.

4. The security case according to claim 1, wherein the security case is at least partially produced from a thermoplastic material.

5. The security case according to claim 1, wherein the protection modules are modules having free-flowing materials, which discharge these materials under pressure to devalue the valuables.

6. The security case according to claim 1, wherein the protection system includes a circuit connected to the protection modules, which causes triggering of the protection modules as soon as an unauthorized manipulation is performed on the security case or the security case is released from the hand.

7. The security case according to claim 1, wherein the protection system allows a keyless access to the strongbox area.

8. The security case according to claim 1, further comprising connection means, which are implemented in such a way that the security case, having the sliding plate in the closed position, is connectable to an external container in such a way that the sliding plate may be moved from its closed position into its release position after being situated on the external container.

9. The security case according to claim 1, further comprising an interface to allow a release of the security case using a Pocket PC or computer.

10. The security case according to claim 1, further comprising an interface to read an RFID chip or a bar code, in order to only then allow a release of the security case.

11. The security case according to claim 6, wherein a sidewalk time window is predefinable for the circuit, the automatic neutralization being initiated after the sidewalk time window has been exceeded.

12. A security system comprising:
a security case according to claim 1, and
a storage station having storage points for at least one security case.

13. The security system according to claim 12, wherein at least one of the storage point is implemented in such a way that an energy accumulator and/or the protection system of the security case are restorable.

14. A security complex comprising:
a security case according to claim 8, and
an external container having a closable security opening to be opened,
wherein the security case is connectable to the external container in such a way that the sliding plate adjoins the security opening of the external container in its closed position, and releases a falling path from the strongbox area of the security case into the external container for the valuables in its release position.

15. The security complex according to claim 14, wherein an electrical and/or mechanical contact to the external container is producible by the connection means.

16. The security complex according to claim 14, further comprising a storage station for one or more security cases.

17. The security case according to claim 4, wherein the security case is at least partially produced from a kydex material.

18. The security case according to claim 5, wherein the free-flowing materials are at least one of (i) a liquid and (ii) an ink.

19. The security case according to claim 8, wherein the external container is a strongbox.

20. A security complex according to claim 14, wherein the external container is a strongbox.
